(19) United States
(12) Patent Application Publication
(10) Pub. No.: US 2026/0065363 A1
(43) Pub. Date: Mar. 5, 2026

(54) SYSTEMS AND METHODS FOR CREDIT LINE MANAGEMENT

(71) Applicant: The PNC Financial Services Group, Inc., Pittsburgh, PA (US)

(72) Inventors: Aninda BHATTACHARYYA, Pittsburgh, PA (US); Ramakrishna CHINTAPANTI, Pittsburgh, PA (US); Jess ZACHARIAS, Pittsburgh, PA (US); Stacy KEYSER, Pittsburgh, PA (US); Maciek Janusz DLUGOSZ, Pittsburgh, PA (US); Ashish GUPTA, Pittsburgh, PA (US); Rajesh Kumar SAINI, Pittsburgh, PA (US); Sachin KESHARI, Pittsburgh, PA (US)

(73) Assignee: The PNC Financial Services Group, Inc., Pittsburgh, PA (US)

(21) Appl. No.: 19/384,276

(22) Filed: Nov. 10, 2025

Related U.S. Application Data
(63) Continuation of application No. 18/799,257, filed on Aug. 9, 2024.
(60) Provisional application No. 63/632,993, filed on Apr. 11, 2024.

(51) Int. Cl. G06Q 40/03

(52) U.S. Cl. CPC G06Q 40/03

(57) ABSTRACT

Disclosed systems and methods may receive real-time, external credit line information into one or more source applications. Thereafter, the real-time, external credit line information may be merged with internal credit line information and legacy information via a data orchestrator. The merged information may be further consolidated via the data orchestrator resulting in one or more micro batches of merged credit line information that are transmitted to a credit line decisioning system at frequent intervals. At least one exclusion rule may be applied to the transmitted credit line information, and thereafter, the transmitted credit line information may be provided to an interactive visual tool for real-time credit line management. The interactive interface allows for a user to incorporate real-time credit line information into credit line management decision-making. Thus, the credit line management system described herein provides real-time credit line information to enable real-time decision-making regarding credit line increase, decrease, and closure.

### CROSS REFERENCE TO RELATED APPLICATIONS

This application claims the benefit of priority of U.S. Provisional Patent Application No. 63/632,993 filed on Apr. 11, 2024, the contents of which are incorporated herein by reference in their entirety.

### BACKGROUND

The present disclosure relates generally to systems and methods for credit line management. More specifically, the present disclosure relates to the retrieval, storage and processing of credit line related data to efficiently manage credit lines in real-time. The present disclosure further relates to providing an interactive visual tool for real-time credit line management.

A financial institution may have millions of credit lines issued at a given time. Credit line management includes an evaluation of each credit line and subsequent decisions based on the evaluation.

Effective credit line management promotes efficient evaluation and decision-making. An effective credit line management function may allow financial institutions to adjust credit lines to increase profitability. For example, it may be profitable to increase credit lines that data suggests present low risk to financial institutions. Alternatively, it may be profitable to decrease or close credit lines that data suggests present high risk to financial institutions.

Accordingly, a financial institution must plan, manage, and monitor rapidly changing technologies to deliver and support new products, services, and delivery channels, because the rate of these changes and the resulting increased reliance on technology make efficient credit line management an integral aspect to an effective overall lending program.

Known credit line management systems retrieve raw data and format it into file structures. Such systems are batch-based and may cause data acquisition delays of up to 2 days with credit line decision making only occurring once a month, as facilitated by an IBM RULE ENGINE.

Disclosed is a system with credit line management technology enabling real-time monitoring of credit line data to inform daily credit line decision-making, which increases decision-making speed and thereby improves decision-making accuracy and prevents fraud.

### SUMMARY

Systems and methods for credit line management are provided. The systems and methods may comprise receiving real-time, external credit line information into one or more source applications. Thereafter, the real-time, external credit line information may be merged with internal credit line information and legacy information via a data orchestrator. The merged information may be further consolidated via the data orchestrator resulting in one or more micro batches of merged credit line information that are transmitted to a credit line decisioning system at frequent intervals. At least one exclusion rule may be applied to the transmitted credit line information, and thereafter, the transmitted credit line information may be provided to an interactive visual tool for real-time credit line management.

In some embodiments, the bank systems data may include at least one of a deposit account balance, an average balance, an account usage, a delinquency, a customer address, or a customer identification number. In some embodiments, the legacy decisioning platform data may include a past credit line decision related to an account. In some embodiments, the data orchestrator may include a consumer client, a FICO orchestrator, a data workflow, and a producer client. In some embodiments, the credit line decisioning system may include a decision orchestrator, a line management evaluator, and a line management assignor. In some embodiments, the system may assign, using the credit line decisioning system, a credit decision path based on the one or more records. In some embodiments, the credit decision path is chosen from the set of: credit line increase, credit line decrease, and credit line closure. In some embodiments, the system may transmit, using a second streaming platform, the credit decision path to a downstream system. In some embodiments, the system may include transmitting, using a third streaming platform, audit and reporting data to a reporting and analysis system. Implementations of the described techniques may include hardware, a method or process, or a computer tangible medium. In some embodiments, one or more devices that are configured or operable to perform the above-described systems and methods are disclosed.

Throughout, this disclosure the phrase “disclosed embodiments,” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that both the foregoing general description and the following detailed description are exemplary and explanatory only, and are not restrictive of the disclosed embodiments, as claimed.

### BRIEF DESCRIPTION OF FIGURES

The accompanying drawings, which are incorporated in and constitute a part of this specification, illustrate disclosed embodiments and, together with the description, serve to explain the disclosed embodiments. In the drawings:

FIG. 1 is a schematic diagram of members of an institution expressing their desire to improve auditing technology, consistent with some disclosed embodiments.

FIG. 2 is a schematic diagram of members of an institution expressing a solution, consistent with some disclosed embodiments.

FIG. 3-5 are schematic block diagrams of various components of a credit line management system, consistent with some disclosed embodiments.

FIG. 6 is a schematic diagram of an exemplary data flow for a credit line management system, consistent with some disclosed embodiments.

FIG. 7 is a schematic diagram of an exemplary data flow from raw data sources to feature stores and topics, consistent with some disclosed embodiments.

FIG. 8 is a schematic diagram of an exemplary data flow architecture for storing and managing customer information, consistent with some disclosed embodiments.

FIG. 9 is a schematic diagram of an exemplary data flow architecture for behavior model-as-a-service implementation, consistent with some disclosed embodiments.

FIG. 10 is a schematic diagram of an exemplary data flow architecture for external data ingestion, consistent with some disclosed embodiments.

FIG. 11 is a schematic diagram of an exemplary data flow architecture for outbound coordination, consistent with some disclosed embodiments.

FIG. 12 is a schematic diagram of an exemplary data flow architecture for decisioning and action outcomes processing, consistent with some disclosed embodiments.

FIG. 13-15 are flowcharts of exemplary operations of a credit line management system, consistent with some disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

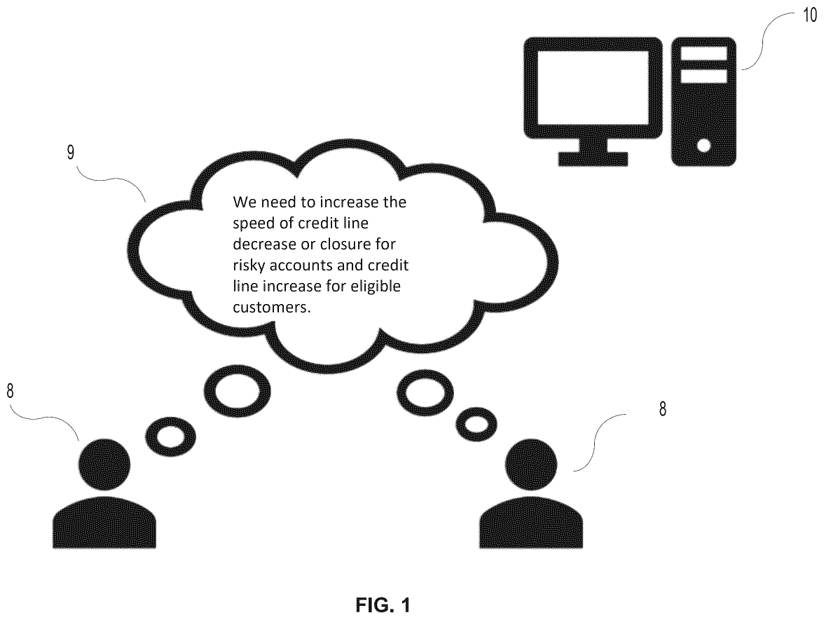

FIG. 1 is a schematic diagram of employees of a company expressing a desire to increase the speed of credit line decrease or closure for risky accounts and credit line increase for eligible customers, consistent with disclosed embodiments. Corporate directors 8 may express a desire 9 to increase the speed of credit line decrease or closure for risky accounts and credit line increase for eligible customers. The corporate directors 8 may utilize a credit line management system 10 for such an increase in speed.

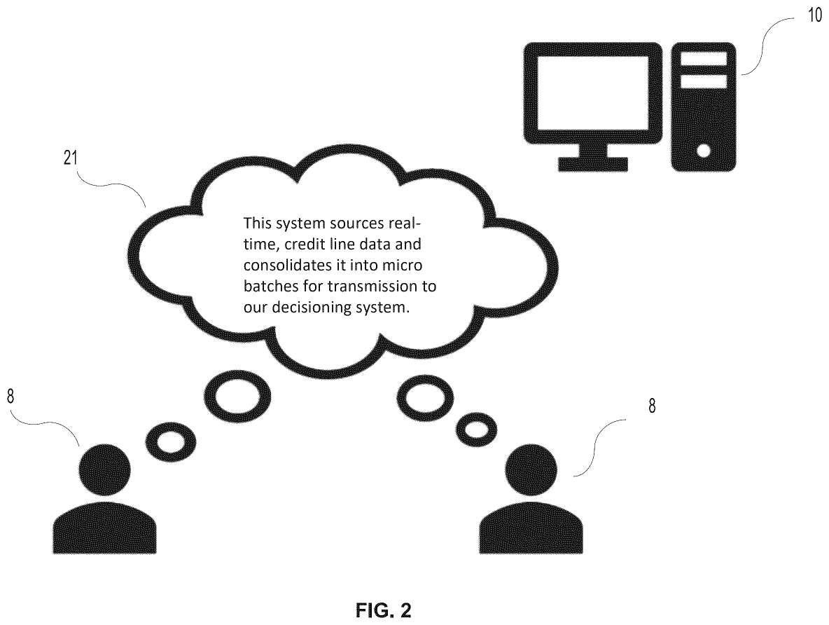

FIG. 2 is a schematic diagram of employees of a company expressing a solution, consistent with disclosed embodiments, for increasing the speed of credit line decrease or closure for risky accounts and credit line increase for eligible customers consistent with disclosed embodiments. Corporate directors 8 may express a solution 21 associated with credit line management system 10 for increasing the speed of credit line decrease or closure for risky accounts and credit line increase for eligible customers.

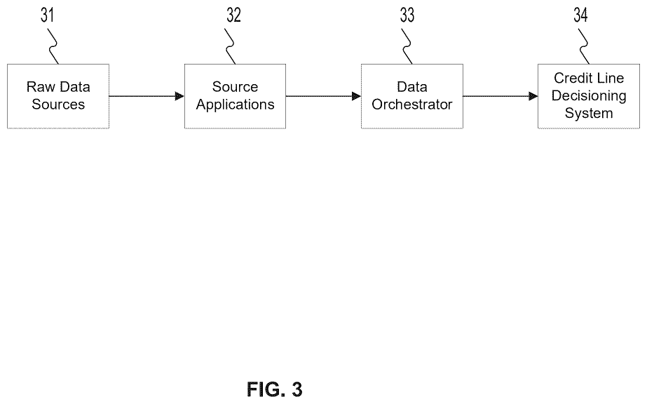

FIG. 3 is a schematic diagram of exemplary components of a credit line management system, consistent with some disclosed embodiments. In operation, raw data 31 is introduced into the credit line management system. Raw data may be in the form of external credit line data, internal account data, and legacy decisioning platform data. External credit line data may also be referred to as Bureau data and may include data related to credit lines outside the financial institution as well as credit lines issued by the financial institution. For example, raw data may include external credit line data from a financial clearing platform. Internal account data may include bank systems data such as deposit account balance; average balance; account usage, including overuse; any delinquencies; customer address; and customer identification numbers. Internal account data may be stored in a data storage. Legacy decisioning platform data may include past credit line decisions related to an account. Legacy decisioning platform data may also be stored in a data storage.

The raw data 31 may be placed in source applications 32. The source applications 32 function as a centralized master repository for the data used in the credit line management process. Any number of source applications may be employed. According to some of the example embodiments, different source applications may be dedicated to different forms of input data. In some embodiments, external credit line data may be sourced via a Secure FTP process. In some embodiments a data streaming platform is used to stream external credit line data. In some embodiments the data streaming platform is a KAFKA data streaming platform comprising KAFKA topics. In some embodiments, source applications include applications with a HADOOP framework and GRAPHQL.

FIG. 3 further illustrates a data orchestrator 33 that may be configured to receive credit line data from the source applications 32 for consolidation. In some embodiments, credit line data from the source applications may include one or more records based on customer account data. The data orchestrator 33 may combine data from multiple source applications and make the data available for analysis. Data orchestrator 33 may consolidate credit line data received from source applications into one or more micro batches and transmit the one or more micro batches to a credit line decisioning system. In some embodiments, data orchestrator 33 consolidates credit line data from up to a maximum number of credit accounts into a single micro batch and transmits consolidated micro batches at a set interval of time. In some embodiments, if credit line data for the maximum number of credit accounts is not reached by the expiration of the set interval of time, the credit line data that has been received is consolidated into a micro batch and transmitted. In some embodiments, the maximum number of credit accounts for which credit line data is consolidated into a single batch is 30 credit accounts, and the set interval is 5 seconds. At this point, records may include calculated behavior scores for each account, consolidated account records, and customer attributes required for line management decisions. In some embodiments, the data orchestrator may comprise a data workflow. The data workflow may represent a predefined sequence of tasks, operations, and decisions that need to be executed to process and transform data from its raw form to a consumable state. It may, for instance, define the steps involved in data ingestion, cleansing, transformation, enrichment, and delivery.

Thereafter, micro batches of consolidated credit line data are received by a credit line decisioning system 34. In some embodiments, credit line decisioning system 34 may include a FICO platform. In some embodiments, credit line decisioning system 34 may access the records via one or more application program interfaces (“APIs”) and receive the records as inputs.

Thereafter, credit line decisioning system 34 may apply one or more global exclusion rules formulated to remove credit line data for accounts that do not require decisioning. Credit line data for accounts that do not require decisioning, also referred to herein as exception records, includes data regarding perfect credit scores, lost credit cards, and stolen credit cards. Thereafter, credit line decisioning system 34 may assign a credit decision path to each account, including credit line increase, credit line decrease, and credit line closure. Thereafter, credit line decisioning system 34 may apply one or more local exclusion rules formulated to remove residual credit line data that does not require decisioning, including records of perfect credit scores, lost credit cards, and stolen credit cards.

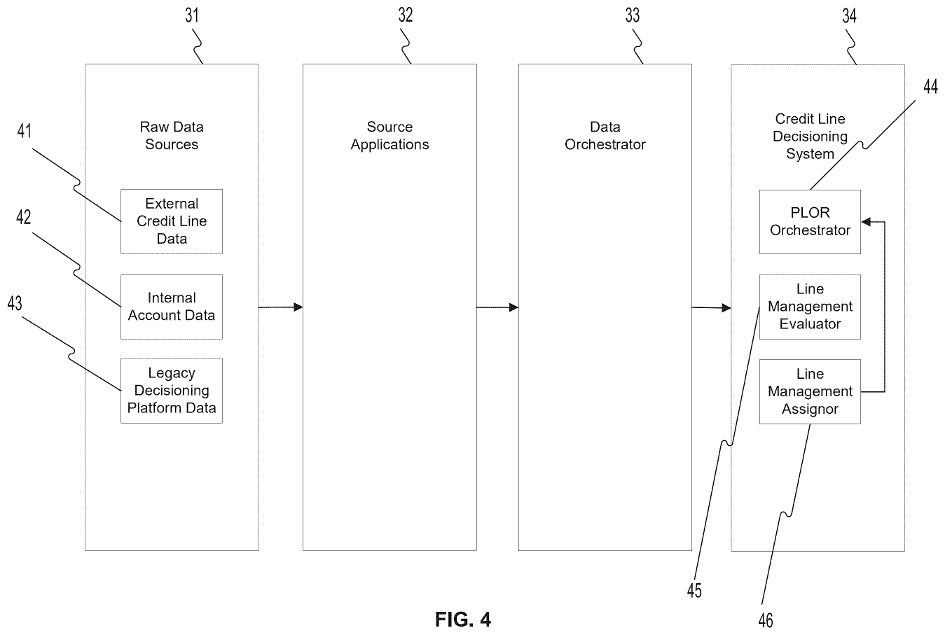

FIG. 4 is a schematic diagram of exemplary components of a credit line management system, consistent with some disclosed embodiments. In the depicted example, the credit line management system may comprise raw data sources 31, source applications 32, data orchestrator 33, and credit line decisioning system 34.

Raw data sources 31 may represent the sources from which the credit line management system obtains its data. In the non-exhaustive example of FIG. 4, for instance, there are three types of raw data sources: external credit line data 41, internal account data 42, and legacy decisioning platform data 43. External credit line data 41 may include data related to credit lines outside the financial institution, as well as credit lines issued by the financial institution. Internal account data 42 may include data stored in a bank's systems, such as deposit account balances, average balances, account usage (including overuse), delinquencies, customer addresses, and customer identification numbers. This data may be stored in a data storage system. Legacy decisioning platform data 43 may include past credit line decisions related to an account. This data may also be stored in a data storage system.

Source applications 32 may represent the applications that store and manage the raw data sources. There can be any number of source applications, each dedicated to different forms of input data, such as a secure file transfer protocol process used to receive external credit line data, or a platform used to stream external credit line data. Examples may include KAFKA data streaming platforms comprising KAFKA topics or HADOOP frameworks with GRAPHQL.

Data orchestrator 33 may receive credit line data from the source applications and consolidate it into one or more micro batches. It may then transmit these micro batches to the credit line decisioning system for analysis.

Credit line decisioning system 34 may be responsible for making decisions about credit lines. The system may receive consolidated data from the data orchestrator and apply exclusion rules to determine which accounts require decisioning. In the depicted example, credit line decisioning system 34 may comprise PLOR data orchestrator 44, line management evaluator 45, and line management assignor 46. PLOR stands for Platform Orchestrator. The PLOR data orchestrator may be a service integrator and gateway with decisioning components. It may orchestrate the flow of data between different systems and applications, ensuring that all relevant data is collected and processed, and may perform, among other things, high-level record validation on the raw data sources. Line management evaluator 45 may evaluate the credit line data received from the source applications to determine whether a credit line requires decisioning. Line management assignor 46 may apply grid-based exclusion rules to determine which accounts require decisioning and assign a credit decision path to each account. The output of the credit line management system may be the assignment of a credit decision path to each account, including credit line increase, decrease, or closure.

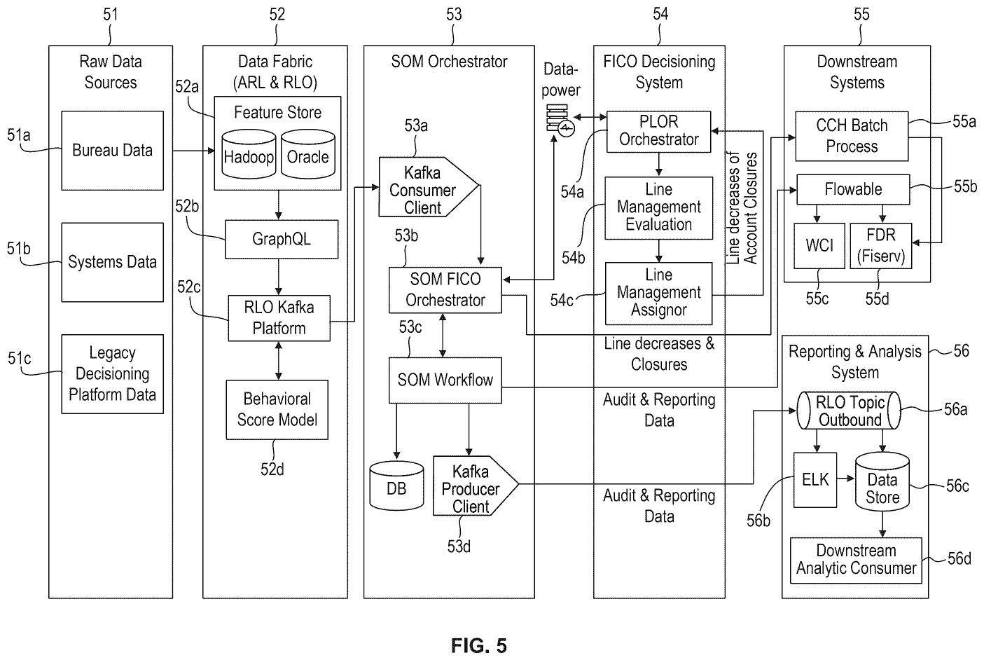

FIG. 5 is a schematic block diagrams of various components of a credit line management system, consistent with some disclosed embodiments. In the depicted embodiment, the exemplary credit line management system may comprise raw data sources 51, data fabric 52, SOM orchestrator 53, FICO decisioning system 54, downstream systems 55, and reporting and analysis system 56.

Raw data sources 51 may be the primary sources of data for the credit line management system. In the depicted example, for instance, there are three types of raw data although additional or fewer sources may be used: bureau data 51a, systems data 51b, and legacy decisioning platform data 51c. Bureau data 51a may represent external credit line data from a financial clearing platform, which may include data related to credit lines outside the financial institution as well as credit lines issued by the financial institution. Systems data 51b may include internal account data stored in a data storage, such as deposit account balance, average balance, account usage, including overuse or delinquencies, customer address, and customer identification numbers. Legacy decisioning platform data 51c may represent past credit line decisions related to an account, which may also be stored in a data storage.

Data fabric (ARL and RLO) 52 may be a layer that consolidates raw data from various sources for analysis. ARL stands for Retail Lending Data Fabric, serving as a data ingestion platform for lending data. RLO stands for Retail Lending Orchestrator, serving as a data connector (e.g., via API) and orchestrator for lending data movement and analytics integration. In the depicted embodiment, data fabric 52 may comprise feature store 52a, GRAPHQL 52b, RLO KAFKA platform 52c, and behavioral score model 52d. Feature store 52a may represent a storage component that holds features extracted from the raw data. Features may include customer attributes, transactional data, and other relevant information used in the credit line management process. GRAPHQL 52b may represent a query language for managing and accessing data stored in the feature store. GRAPHQL may allow for flexible querying and manipulation of the feature data. RLO KAFKA platform 52c may represent a distributed event-driven platform that enables real-time processing and analysis of data streams. The RLO KAFKA platform may be used to stream external credit line data, allowing for real-time or near-real-time decisioning and management of credit lines. Behavioral score model 52d may represent one or more algorithms to analyze behavioral data and generate scores indicating the likelihood of a customer's creditworthiness. For instance, it may comprise a predictive model that uses machine learning algorithms to analyze behavioral data and generate scores indicating the likelihood of a customer's creditworthiness. The behavioral score model may be trained on historical data and updated in real-time as new data becomes available.

In some embodiments, a predictive model utilizing machine learning algorithms may be employed to analyze behavioral data and generate scores indicating the likelihood of a customer's creditworthiness. The machine learning algorithms, also referred to as machine learning models or artificial intelligence, can be trained using training examples. These algorithms may include classification algorithms, data regression algorithms, support vector machines, random forests, nearest neighbors algorithms, deep learning algorithms, artificial neural network algorithms, convolutional neural network algorithms, recursive neural network algorithms, linear machine learning models, non-linear machine learning models, and ensemble algorithms, among others. The trained machine learning algorithm, which may comprise an inference model such as a predictive model, classification model, regression model, clustering model, segmentation model, or an artificial neural network (e.g., deep neural network, convolutional neural network, recursive neural network), among others, can be used to estimate creditworthiness scores for customers whose data was not included in the training examples. The training examples may include example inputs together with the desired outputs corresponding to the example inputs. To evaluate the performance of the trained or intermediately trained machine learning algorithm, validation examples and/or test examples may be used. These examples may also include example inputs with their corresponding desired outputs. The algorithm may then estimate outputs for the example inputs, and the estimated outputs may be compared to the corresponding desired outputs. The algorithm may then be evaluated based on the result of this comparison. Machine learning algorithms often have parameters and hyperparameters. Hyperparameters may be set manually by a person or automatically by an external process, such as a hyperparameter search algorithm, while the parameters may be set by the machine learning algorithm according to the training examples. In some implementations, the hyperparameters may be set according to the training examples and the validation examples, and the parameters may be set according to the training examples and the selected hyperparameters. By employing these machine learning techniques, the predictive model can effectively analyze a customer's behavioral data and generate a creditworthiness score, which can be used by financial institutions to make informed decisions regarding credit applications, loan approvals, and risk assessment, among other functions.

SOM orchestrator 53 may receive credit line data from the data fabric and make it available for analysis. SOM stands for Service Order Management. In the depicted example, SOM orchestrator 53 may comprise KAFKA consumer client 53a, SOM FICO orchestrator 53b, SOM workflow 53c, KAFKA producer client 53d, and one or more internal or external databases. KAFKA consumer client 53a may be a client that consumes messages from a KAFKA topic, which may be used to stream external credit line data. The KAFKA consumer client 53a may receive data from RLO KAFKA platform 52c, for instance, which may include credit line optimization events, such as credit line adjustments, risk assessments, or other relevant information. SOM FICO orchestrator 53b may orchestrate the workflow of the credit line management system. FICO stands for FAIR ISAAC CORPORATION, a well-known provider of credit scoring solutions. As depicted, for instance, the SOM FICO orchestrator may transmit data related to credit line decreases and closures to the Bank Card Processing (CCH) batch process 55a. This data may include information about customers whose credit lines have been decreased or closed based on the decisions made by the FICO orchestrator. The Bank Card Processing (CCH) batch process 55a may process this data and update the relevant credit card processing records. SOM workflow 53c may be the workflow that the SOM FICO orchestrator manages. The workflow may include various steps and processes involved in managing credit lines. As shown, for instance, the SOM workflow may transmit audit and reporting data to flowable 55b. This data may include information about the execution of credit line management workflows, such as process performance metrics, task assignments, and decision outcomes, among others. Flowable 55b, being a workflow management system, may use this data to monitor and report on the efficiency and effectiveness of the credit line management processes. Additionally, as illustrated, the workflow may be in communication with one or more external or internal databases. KAFKA producer client 53d may be a client that produces messages to a KAFKA topic, which may be used to stream external credit line data. As shown, for instance, the KAFKA producer client may transmit audit and reporting data to the RLO topic outbound 56a. This data may include information about credit line optimization events, decisions, and performance metrics, among others. The RLO topic outbound 56a, being part of the reporting and analysis system, may consume this data for further analysis and reporting purposes.

FICO decisioning system 54 may be a platform that applies decision rules to credit line data to determine whether an account requires an action. In the illustrative example, the FICO decisioning system may comprise a decision orchestrator 54a (e.g., a PLOR orchestrator), line management evaluation 54b, and line management assignor 54c. Decision orchestrator 54a may orchestrate the flow of data between different systems and applications, ensuring that all relevant data is collected and processed. Line management evaluator 54b may evaluate the credit line data received from the data orchestrator to determine which accounts require decisioning. Line management assignor 54c may assign a credit decision path to each account, including credit line increase, decrease, or closure. In some embodiments, the FICO decisioning system may apply global exclusion rules to remove unnecessary credit line data and assigns a credit decision path to each account. Global exclusion rules, for instance, may be used to remove credit line data for accounts that do not require decisioning. Examples may include records of perfect credit scores, lost credit cards, and stolen credit cards.

Downstream systems 55 may be the systems that receive output from the FICO decisioning system and support the end-to-end credit line management process. In the illustrative embodiment, downstream systems include Bank Card Processing (CCH) batch process 55a, flowable 55b, Written Communication Integration (WCI) 55c, and FDR system 55d. CCH batch process 55a may be a batch processing system that handles large volumes of credit-related data in batches. Bank Card Processing (CCH) batch process 55a may be responsible for tasks such as consolidating credit card transaction data from various sources, applying processing rules or calculations, and preparing the data for use by other systems, acting as a gateway and integration layer with the credit card data processing vendor. The processed data may be used for credit line optimization, risk assessment, or other credit-related decisions. As illustrated, for instance, the CCH batch process may transmit data to the FDR system 55d. This data may include the updated customer information, such as changes in credit lines, account statuses, and risk profiles, among others. The FDR system 55d, may be configured to access, change, store, and maintain customers'financial statements, pricing information, history, and scoring information, among other data. In some embodiments, for instance, it may update behavior scores on a periodic basis (e.g., a daily, weekly, or monthly basis). Flowable 55b may represent any suitable process management and/or workflow engine. It may be used to define, execute, and monitor business processes related to credit line management. It may help automate and streamline complex workflows, such as credit application processing, credit line adjustments, or dispute resolution. Flowable 55b may allow for the creation of visual process diagrams, the assignment of tasks to users or systems, and the tracking of process performance metrics. Written Communication Integration (WCI) component 55c may serve as a unified communication system for generating and managing written customer interactions. It may handle various forms of written communication sent to customers, such as letters, emails, or notifications. For instance, it may be used to generate written communications sent to customers regarding their accounts, such as adverse action letters. Similarly, it may incorporate content management capabilities to ensure consistent messaging across different communication channels. This component may incorporate rules-based decisioning, human review, and other processes to ensure accurate and timely decisions on credit line applications or adjustments. It may integrate with other systems, such as credit scoring models or fraud detection tools, to support informed decision-making. FDR system 55d may be a system that manages large volumes of financial data. It may provide secure, scalable functionality for accessing, changing, storing, and maintaining data such as financial statements, pricing information, customer history, and scoring information, among other data. In the non-limiting embodiment, for instance, the FDR system may be a division of Fiserv, a major provider of financial services technology and solutions.

Reporting and analysis system 56 may be responsible for generating reports and performing analytics on the credit line data. In some embodiments, for instance, it may analyze and report decisions and trends to stakeholders and other users. In the illustrative example, the reporting and analysis system comprises RLO topic outbound 56a, ELK 56b, data store 56c, and downstream analytic consumer 56d. RLO topic outbound 56a may be responsible for receiving data from the Retail Lending Orchestrator (RLO) system, such as via KAFKA topics or other messaging protocols. It may serve as an interface between the RLO system and the reporting and analysis system, ensuring that relevant data is efficiently transferred for further processing and analysis. ELK 56b may be used to ingest, process, and index the data received from the RLO topic outbound 56a. ELK stands for ELASTICSEARCH, LOGSTASH, and KIBANA, which is used for log management, data analysis, and visualization. However, any other suitable methods may be employed. ELASTISEARCH can store and search through large volumes of data, LOGSTASH can transform and enrich the data, and KIBANA can provide a user-friendly interface for creating dashboards and visualizations. Data store 56c may be a data storage system that retains the processed and analyzed data from the ELK stack and/or the RLO topic outbound. It may be a database (e.g., SQL or NoSQL), a data warehouse, or a distributed storage system like HADOOP. The data store may enable the long-term storage and retrieval of historical data for reporting, trend analysis, and other analytical purposes. Downstream analytic consumer 56d may represent the various systems, tools, or users that consume the data and insights generated by the reporting and analysis system. Examples could include business intelligence tools (e.g., TABLEAU, POWER BI), statistical analysis software (e.g., SAS, R), or custom applications built for specific analytical use cases. These downstream consumers may use the data and reports to make informed decisions, monitor performance, and identify trends or anomalies related to credit line management.

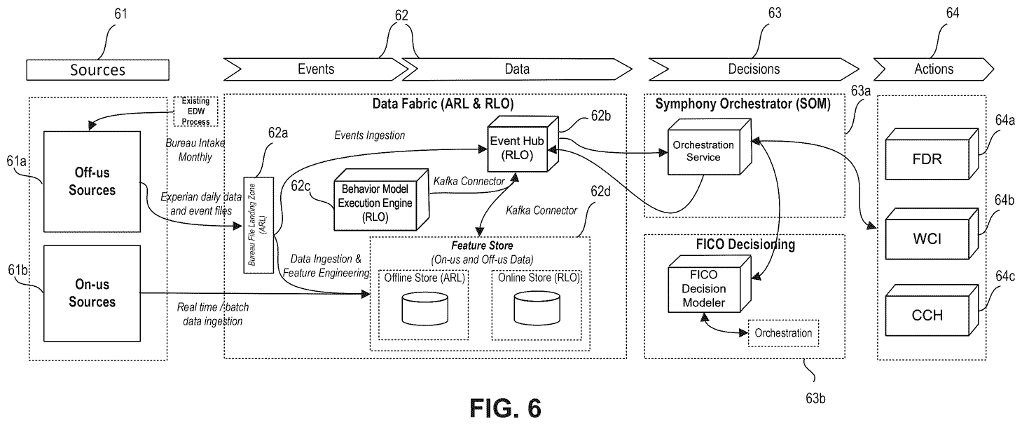

FIG. 6 is a schematic diagram of an exemplary data flow for a credit line management system, consistent with some disclosed embodiments. In the depicted embodiment, the exemplary credit line management system may comprise sources 61, events and data 62, decisions 63, and actions 64.

Sources 61 may represent the sources from which the financial institution obtains its data. It may comprise “off-us” sources 61a and “on-us” sources 61b. Off-us sources 61a may represent external data sources that the financial institution will use to gather information about its customers. Examples may include data from Experian, a credit reporting agency. Off-us sources may receive data from existing Enterprise Data Warehouse (EDW) processes. For instance, it may receive a file sent to Experian or another bureau from financial institutions defining account/borrower population in-scope for generating triggers. This process may not need to change the existing EDW process. Off-us sources may output two types of files: periodic (e.g., daily) files including data and events for accounts meeting trigger criteria, and periodic (e.g., monthly) files including data for the full population. On-us sources 61b may be internal data sources that the financial institution already has access to, such as a customer relationship file (CRF) and servicing systems. On-us sources may produce real-time/batch data ingestion for feature store 62d. Feature store tables may be populated with features generated based on data extracted from the financial institutions'systems of record (SORs) for both real-time and batch data ingestion.

Events and data 62 may refer to the events and data that are received from sources 61. Events may be used to trigger actions or decisions in the system. Data may comprise various types of data that are ingested into the system, including customer relationship level (CRF), credit inquiries, income data, and servicing systems data, among others. As shown, events and data 62 may be handled by the Data Fabric (ARL & RLO), discussed in more detail herein, which may comprise Bureau File Landing Zone (ARL) 62a, Event Hub (RLO) 62b, Behavior Model Execution Engine (RLO) 62c, and Feature Store 62d. ARL stands for Retail Lending Data Fabric, while RLO stands for Retail Lending Orchestrator. Bureau File Landing Zone (ARL) 62a may be a landing zone where files from various sources are parsed and processed. For example, it may be a landing zone for bureau file data from off-us sources, such as Experian. It may receive periodic (e.g., daily) trigger files with event control files and create events in the Event Hub (RLO). Event Hub (RLO) 62b may be a hub that receives events ingestion from the Bureau File Landing Zone (ARL). It may generate KAFKA topics including data and events required for Line Management to be consumed by SOM orchestration service. It may integrate data and event information relevant for line management from the feature store with behavior model execution outputs. It may comprise a KAFKA connector to the Behavior Model Execution Engine (RLO) 62c. Behavior Model Execution Engine (RLO) 62c may be an engine that executes behavior models based on the data and events in the Event Hub. It may have a KAFKA connector to the Event Hub (RLO) and the Feature Store. Feature Store 62d may be a store that receives data ingestion and feature engineering from the Bureau File Landing Zone (ARL) and real-time/batch data ingestion from on-us sources. The Feature Store may contain various feature groups, including off-us customer relationship features, on-us customer relationship features, credit line management decision logs, events, cards account level features, and integrated credit cards account level features, among others. As shown, it may be partitioned into an offline store (ARL) and an online store (RLO).

Decisions 63 may refer to the outcomes or actions taken as a result of analyzing data and events. These decisions can be used to inform business processes, such as credit line management, account closures, or adverse action letters. Decisions may be implemented by Symphony Orchestrator (SOM) 63a and FICO Decisioning 63b. SOM 63a may be an orchestration service that generates KAFKA topics including data and events required for line management to be consumed by the SOM orchestration service. It may persist decision action outcomes and any errors as well as the original input data to RLO via KAFKA topic. FICO Decisioning 63b may comprise a FICO decision modeler and an orchestration component. The orchestration component may orchestrate services that invoke the FICO decision modeler to obtain decision outcomes.

Actions 64 may represent specific steps or tasks that will be performed to support risk reduction, line management processes, and other business outcomes. The orchestration process may invoke real-time APIs or batch jobs to perform actions such as line decrease or closure. As depicted, actions may be implemented using FDR component 64a, Written Communication Integration (WCI) component 64b, and Bank Card Processing (CCH) component 64c. FDR component 64a may function as system used to access, change, store, and maintain financial data related to customers, including financial statements, pricing information, account history, and scoring information. The FDR may serve as a single source of truth for comprehensive account information. Written Communication Integration (WCI) component 64b may function as a platform for written customer interactions. It may unify the process of generating, managing, and delivering various forms of written communication to customers, including letters, emails, and notifications. WCI's content management capabilities may help ensure consistency and compliance in all customer-facing written communications, such as account-related notifications or adverse action letters. Bank Card Processing (CCH) component 64c may represent the gateway and integration layer for credit card data processing. It may handle various factors such as transaction processing, authorization requests, settlement data, and other relevant credit card-related information. For instance, the customer's behavior score may be updated in their credit history.

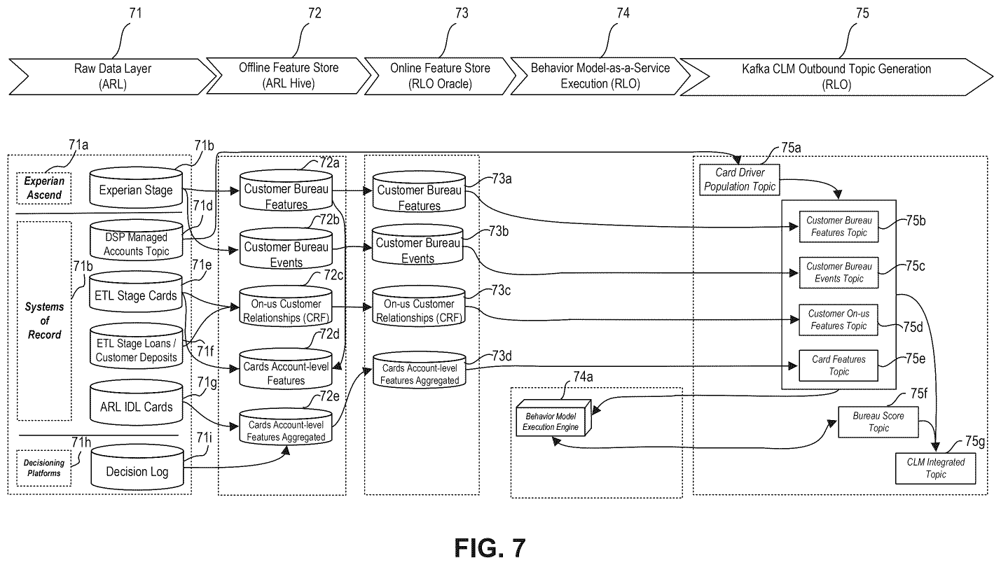

FIG. 7 is a schematic diagram of an exemplary data flow from raw data sources to feature stores and topics, consistent with some disclosed embodiments. In the depicted embodiment, the exemplary data flow may comprise raw data layer (ARL) 71, offline feature store (ARL Hive) 72, online feature store (RLO ORACLE) 73, Behavior Model-as-a-Service Execution (RLO) 74, and KAFKA CLM Outbound topic generation (RLO) 75.

Raw data layer (ARL) 71 may contain attributes that can be used to derive features or are consumed directly by the system. It may provide the foundation for subsequent processing and decision-making. It may comprise the following components. EXPERIAN ASCEND 71a may be a source system containing consumer credit reporting (e.g., EXPERIAN) data. Experian Stage 71b may be a staging area for consumer credit reporting (e.g., EXPERIAN) data. Systems of Record 71c may represent various systems of record that store and manage business data. Data Streaming Platform (DSP) Managed Accounts Topic 71d may be a topic related to managed accounts from the DSP system. ETL Stage Cards 71e may be a staging area for card data processed through an ETL (Extract, Transform, Load) process. ETL Stage Loans / Consumer Deposits 71f may be a staging area for loan and consumer deposit data processed through ETL. ARL IDL Cards 71g may be a system related to card data in the ARL (Retail Lending Data Fabric) layer. Decision Log 71i may be a log that stores decision data, such as data related to credit decisions or account decisions.

Offline Feature Store (ARL Hive) 72 may be a set of feature store Hive tables that contain historical snapshots of feature values for each customer or account. It may, for instance, process raw data from various sources, such as EXPERIAN, and apply custom SPARK frameworks to derive features on top of these attributes. This data may be used for analytical and model development/recalibration purposes. It may comprise the following components. Customer Bureau Features Database 72a may be a feature store containing customer bureau features derived from external data sources (e.g., credit bureaus). For example, this database may contain features related to customers' credit profiles, including bureau scores, relationship-level features, and other relevant information. Customer Bureau Events Database 72b may be a feature store containing customer bureau events. This database may contain, for instance, events generated by EXPERIAN, which may be used to derive features or consumed directly by the API. On-Us Customer Relationships (CRF) Database 72c may be a feature store containing on-premises customer relationship data from the Customer Relationship File (CRF). It may contain, for example, data on customers with relationships to the financial institutions that are either in open state or have non-zero balances and are not charged-off. Cards Account-Level Features Database 72d may be a feature store containing account-level features for credit cards, including unsecured credit card accounts. Cards Account-Level Features Aggregated Database 72e may be a feature store containing aggregated features derived at an account level for consumer card accounts, including unsecured credit card accounts. As represented by the arrows pointing from the Raw Data Layer (ARL) components (e.g., EXPERIAN ASCEND, DPS Managed Accounts Topic, ETL Stage Cards, etc.) to the Offline Feature Store (ARL Hive) components, data from the raw data sources may move or be ingested into the respective feature stores in the Hive layer.

Online Feature Store ORACLE (RLO) 73 may be a set of ORACLE tables that contain recent snapshots (e.g., the five most recent snapshots) of feature values for each customer or account. The feature data in the Online Feature Store may be used to support real-time decision-making and modeling applications. This store may be populated from the Offline Feature Store (e.g., using CLOUDERA ENVELOPE MODEL execution), and it may provide real-time access to feature data for analytical and model development use cases. The Online Feature Store may include several feature groups, which may include sets of features derived at an account level for consumer card accounts. These groups may include, for instance, Customer Bureau Features Database 73a, Customer Bureau Events Database 73b, On-Us Customer Relationships (CRF) Database 73c, and Cards Account-Level Features Database 73d, previously discussed. As represented by the arrows pointing from the Offline Feature Store (ARL Hive) components to the corresponding Online Feature Store (RLO ORACLE) components, data in the Hive feature stores may be transferred, replicated, or processed to the corresponding feature stores in the RLO ORACLE layer.

Behavior Model-as-a-Service Execution (RLO) 74 may be a high-level data flow that enables the execution of behavior models. This process may involve populating feature stores with customer relationship data, credit inquiries, income, and other relevant attributes. The goal may be to create a comprehensive view of each customer's behavior, which can be used for analytical and model development purposes. It may be implemented via a Behavior Model Execution Engine 74a, which may be the underlying technology that enables the execution of behavior models. It may subsequently output a score or result generated by the behavior model execution. As depicted by the arrows from the various feature and event topics from the KAFKA CLM Outbound Topic Generation (RLO) component to the Behavior Model component in the Behavior Model-as-a-Service Execution (RLO) layer, the feature and event data may be used as input for executing the behavior model. And as depicted by the arrow from the Behavior Model to the Behavior Score component, the behavior model may generate a behavior score as its output for topic generation.

KAFKA CLM Outbound Topic Generation (RLO) 75 may be a data flow and processing pipeline for generating outbound topics from the KAFKA platform for use in the financial institution's credit line management (CLM) system. It may generate various topics in the KAFKA messaging system, including: Card Driver Population Topic 75a, which may be a topic related to population data; Customer Bureau Features Topic 75b, which may be a topic containing customer bureau features; Customer Bureau Events Topic 75c, which may be a topic containing customer bureau events; Customer On-us Features Topic 75d, which may be a topic containing on-premises customer features; Card Features Topic 75e, which may be a topic containing credit card features; Bureau Score Topic 75f, which may be a topic containing bureau scores, including those related to credit scores; and CLM Integrated Topic 75g, which may be an integrated topic related to credit line management (CLM) data. As indicated by the arrows pointing from various components (Raw Data Layer, Online Feature Store, Behavior Model Execution Engine, etc.) to the KAFKA CLM Outbound Topic Generation (RLO), data from these sources may be used to generate the corresponding KAFKA topics in the CLM Outbound Topic Generation layer.

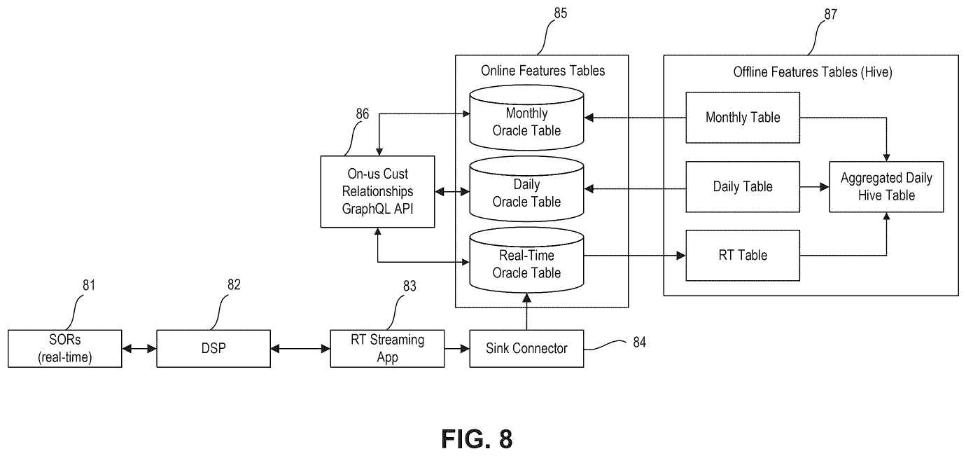

FIG. 8 is a schematic diagram of an exemplary data flow architecture for storing and managing customer information, consistent with some disclosed embodiments. As shown, the architecture may comprise Systems of Record (SORs) 81, Data Streaming Platform (DSP) 82, Real-time (RT) Streaming Application 83, Sink Connector 84, Online Features Tables 85, On-Us Customer Relationships GRAPHQL API 86, and Offline Features Tables (Hive) 87.

Systems of Record (SORs) 81 may refer to one or more systems that maintain and update records. As shown, it may provide real-time data. Data Streaming Platform (DSP) 82 may be hosted by a third-party company that collects, aggregates, or provides access to various types of data. It may be used as a repository or source of data that is ingested from the various SORs. Real-time (RT) Streaming Application 83 may be a real-time streaming application that processes and analyzes data in real-time. It may ingest real-time data from SORs via the DSP. Sink Connector 84 may be a connector that receives and processes data from a source system. It may connect to a data sink (destination) and write or ingest data into it. In the embodiment shown, for instance, the Sink Connector writes the real-time data into the Real-Time ORACLE Table.

Online Features Tables 85 may be online tables that store features or attributes of customers or accounts. As shown, it may comprise one or more tables that store feature data at various frequencies, depicted as a Monthly ORACLE Table which stores monthly feature data, a Daily ORACLE Table that stores daily feature data, and a Real-Time ORACLE Table that stores real-time feature data. On-Us Customer Relationships GRAPHQL API 86 may be a GRAPHQL API that provides access to the financial institution's customer relationship data. As shown, this customer relationship data may be ingested into the Online Features Tables. Offline Features Tables (Hive) 87 may be offline data warehouse (e.g., Hive) tables that store features or attributes of customers or accounts. As shown, it may comprise one or more Hive tables that store feature data at various frequencies, depicted as a Monthly Table that stores monthly feature data, a Daily Table that stores daily feature data, a Real-Time Table that stores real-time feature data, and an Aggregated Daily Hive Table that stores aggregated daily feature data. This architecture may allow for the storage and processing of feature data from various sources, including real-time data streams, customer relationship data, and data from third-party providers. The feature data may be stored in both online (ORACLE) tables and offline (Hive) tables, catering to different frequencies (monthly, daily, real-time) and supporting aggregation and analysis operations.

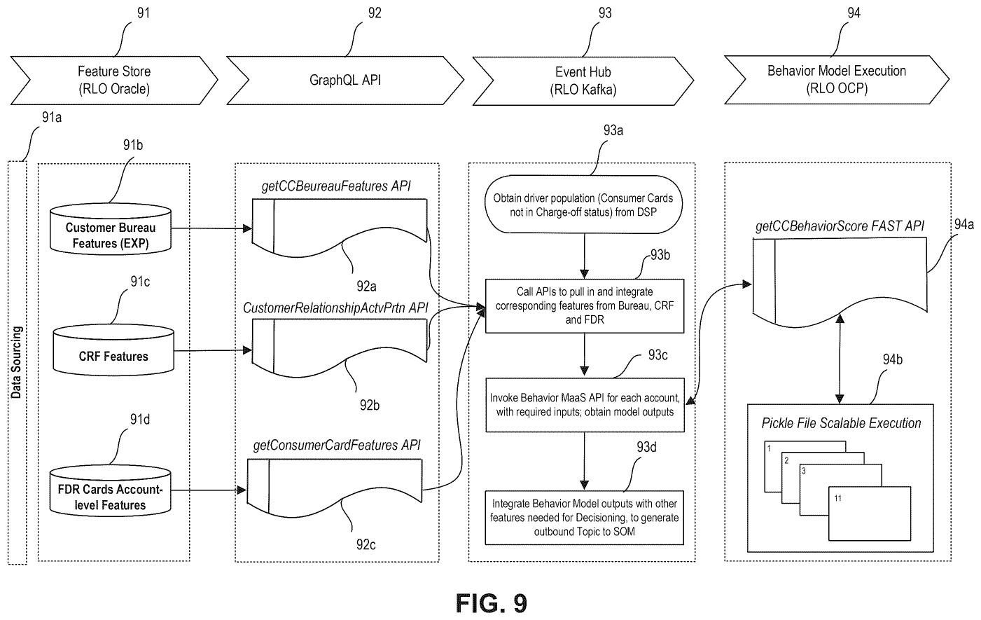

FIG. 9 is a schematic diagram of an exemplary data flow architecture for behavior model-as-a-service implementation, consistent with some disclosed embodiments. As shown, the architecture may comprise Feature Store (RLO ORACLE) 91, GRAPHQL API 92, Event Hub (RLO KAFKA) 93, and Behavior Model Execution (RLO OCP) 94. The overall data flow may start with raw features in the Feature Store, which may be exposed via GRAPHQL APIs. The Event Hub may call these APIs to retrieve relevant features for the target population of active Consumer Card accounts. The Event Hub may integrate these features and pass them to the Behavior Model Execution component. Here, the model API may be invoked with the assembled feature inputs to generate a serialized, executable version of the model for each account. This pickle file may then be used for efficient, on-demand behavioral scoring or decision-making.

Feature Store (RLO ORACLE) 91 may be a repository that stores various features related to customers, such as their behavior, credit risk, and other relevant information. For example, the RLO ORACLE feature store may contain data from EXPERIAN and other sources. Data Sourcing 91a may refer to the process of collecting and retrieving data from various sources, including external databases like EXPERIAN, to populate the feature store. This data may then be used as input for downstream operations, such as behavior modeling and scoring. Feature Store (RLO ORACLE) may include various features, such as Customer Bureau Features (EXP) 91b, CRF Features 91c, and FDR Cards Account-level Features 91d. These features may represent various attributes and metrics about customers and their card accounts, such as demographics, account status, transaction history, credit scores, etc., as previously discussed.

GRAPHQL API 92 may represent the raw features that are exposed and accessed through several GRAPHQL APIs. Each API may retrieve a specific subset of features. For example, getCCBureauFeatures API 92c may pull features from the Customer Bureau (EXP), which may include data from credit bureaus and other external sources about the customer's overall credit profile. CustomerRelationshipAdvPrtn API 92b may retrieve features related to the Customer Relationship File (CRF). The CRF may contain data about the broader customer relationship, beyond just card accounts. getConsumerCardFeatures API 92c may fetch account-level features for FDR cards. Such features may be specific to a particular card product or provider.

Event Hub (RLO KAFKA) 93 may be a central component that integrates various data sources and APIs to generate outbound topics for decision-making. It may start by obtaining a driver population from DSP, which may exclude accounts with charge-off status (step 93a). Then, it may call APIs to pull in corresponding features from Bureau CRF and FDR and receive data from these sources (step 93b). For this driver population, the Event Hub may call the GRAPHQL APIs to pull in the corresponding features from the CRF, Bureau, and FDR sources and integrate them together. This assembles a comprehensive feature set for each account to feed into the behavior model. The Event Hub may also invoke the Behavior Model-as-a-Service (MaaS) API for each account with required inputs and obtain model outputs (step 93c). It may subsequently integrate them with other needed features to generate outbound topics for SOM (step 93d).

Behavior Model Execution (RLO OCP) 94 may refer to the process of executing a behavior model, which may involve receiving input data from invoking the Behavior Model-as-a-Service (MaaS) API for each account (“getCCBehaviorScore FAST API 94a”). The API may take in the assembled feature data as the required inputs and generate the model outputs. The goal may be to obtain model outputs based on the required inputs. These outputs may then be pickled (serialized) into a file that represents a scalable execution of the behavior model (“Pickle File Scalable Execution 94b”). This pickle file can be efficiently loaded and run on demand to generate behavioral insights or predictions for a given account.

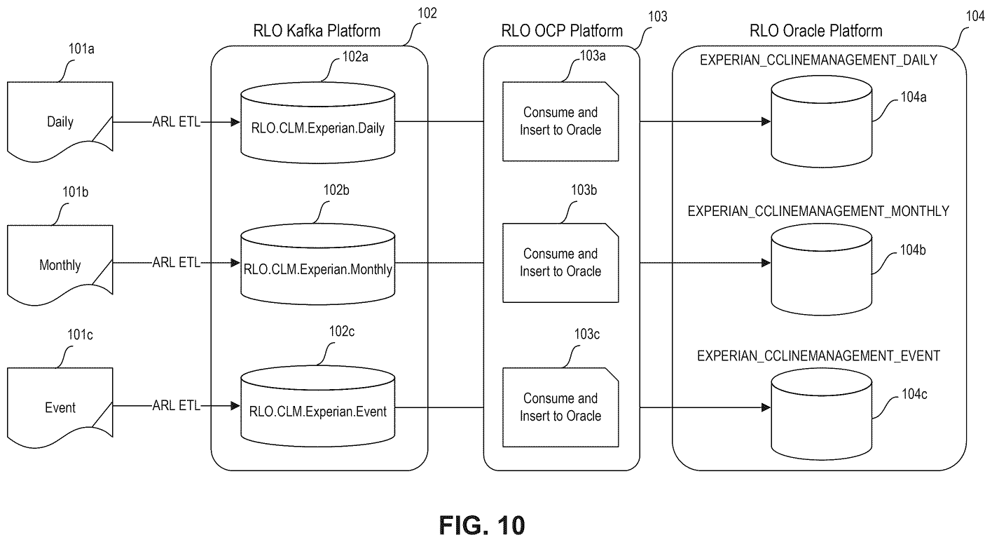

FIG. 10 is a schematic diagram of an exemplary data flow architecture for external data ingestion, consistent with some disclosed embodiments. This architecture may allow for a structured data ingestion and storage pipeline, facilitating the processing and persistence of data from various sources at different frequencies. In the depicted embodiment, the external data ingestion architecture may comprise RLO KAFKA Platform 102, RLO ORACLE Cloud Platform (OCP) Platform 103, and RLO ORACLE Platform 104.

RLO KAFKA Platform 102 may receive data feeds at one or more frequencies. In the depicted example, for instance, the different frequencies include: daily (101a), monthly (101b), and event-based (101c). Each of these data feeds may be processed by an ARl ETL (Extract, Transform, Load) process and stored in corresponding RLO CLM (Credit Line Management) Experian tables within the KAFKA Platform. For example, the daily data feed may be stored in the RLO CLM EXPERIAN Daily table 102a; the monthly data feed may be stored in the RLO CLM Experian Monthly table 102b; and the event data feed may be stored in the RLO CLM EXPERIAN Event table 102c.

RLO OCP Platform 103 may act as an intermediary between the KAFKA Platform and the ORACLE Platform. In the depicted embodiment, it consists of three processes that consume and insert data from the corresponding KAFKA tables into the ORACLE database: daily (103a), monthly (103b), and event-based (103c).

RLO ORACLE Platform 104 may represent the ORACLE database where the data is ultimately stored. In the depicted example, it consists of three tables that receive and store the corresponding data from the OCP Platform: EXPERIAN_CCLINEMANAGEMENT_DAILY table 104a which stores the daily data feed, EXPERIAN_CCLINEMANAGEMENT_MONTHLY table 104b which stores the monthly data feed, and EXPERIAN_CCLINEMANAGEMENT_EVENT table 104c which stores the event-based data feed.

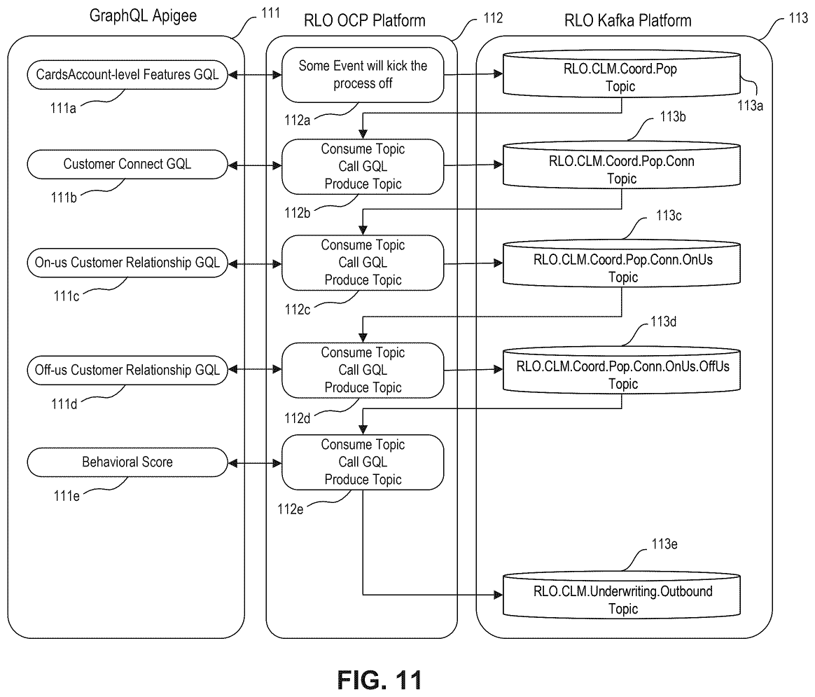

FIG. 11 is a schematic diagram of an exemplary data flow architecture for outbound coordination, consistent with some disclosed embodiments. In the depicted embodiment, the outbound coordination architecture may comprise GRAPHQL APIGEE 111, RLO OCP Platform 112, and RLO KAFKA Platform 113.

GRAPHQL APIGEE 111 may represent a GRAPHQL API gateway, in this instance APIGEE, although any other type of API gateway may be used. It may receive data from various sources, such as: CardsAccount-level Features GQL 111a which may include data related to account-level features related to credit cards; Customer Connect GQL 111b which may include data related to customer connections; On-us Customer Relationship GQL 111c which may include data about customer relationships within the financial institution; Off-us Customer Relationship GQL 111d which may include data related to customer relationships outside the financial institution; and Behavioral Score 111e which may be a score representing customer behavior.

RLO OCP Platform 112 may act as an intermediary between the GRAPHQL APIGEE 111 and the RLO KAFKA Platform 113. It may be triggered by an event that kicks off the process, as depicted by step 112a. The RLO OCP Platform may subsequently perform the following steps for each type of source, as depicted by steps 112b, 112c, 112d, and 112e: consume data from various topics in the RLO KAFKA Platform (“Consume Topic”), call the corresponding GRAPHQL APIs in the APIGEE component (“Call GQL”), and based on the data received from APIGEE, produce new topics in the RLO KAFKA Platform (“Produce Topic”).

RLO KAFKA Platform 113 may represent the APACHE KAFKA messaging system, which may consist of one or more topics. The topics shown in the depicted embodiment, for instance, are: RLO.CLM.Coord.Pop Topic 113a, which may be a topic related to coordinated population data; RLO.CLM.Coord.Pop.Conn Topic 113b, which may be a topic related to coordinated population connection data; RLO.CLM.Coord.Pop.Conn.OnUs Topic 113c, which may be a topic related to on-premises coordinated population connection data; RLO.CLM.Coord.Pop.Conn.OnUs.OffUs Topic 113d, which may be a topic related to both on-premises and off-premises coordinated population connection data; and RLO.CLM.Underwriting.Outbound Topic 113e, which may be a topic related to underwriting outbound data. This architecture may facilitate the integration and data flow between the GRAPHQL API gateway (APIGEE), the intermediary OCP Platform, and the KAFKA messaging system, enabling the processing and distribution of various types of data related to customer relationships, account features, and underwriting.

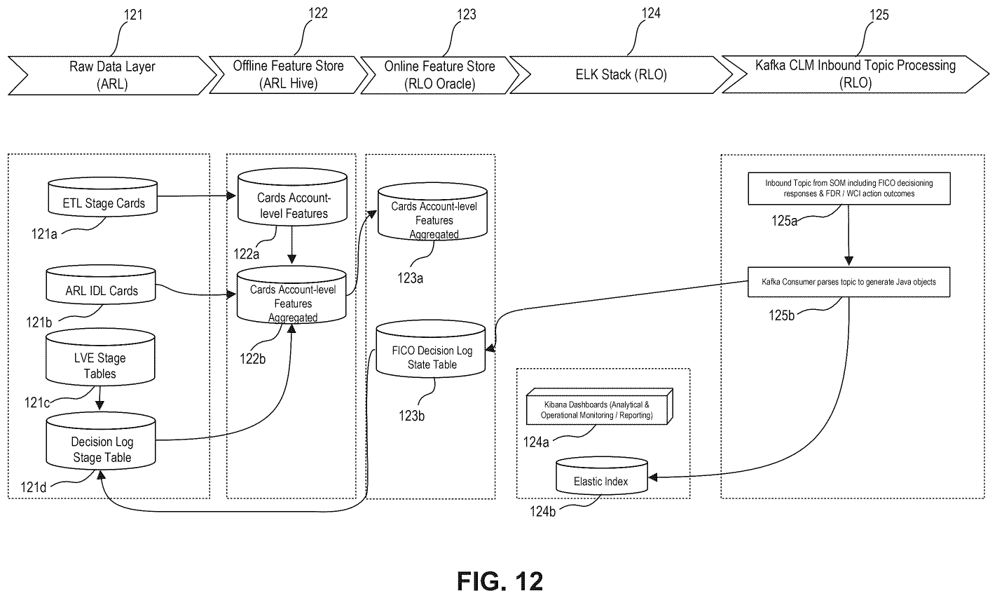

FIG. 12 is a schematic diagram of an exemplary data flow architecture for decisioning and action outcomes processing, consistent with some disclosed embodiments. The architecture may allow for an end-to-end data processing pipeline for ingesting raw data, generating features, and feeding into a decision model and KAFKA topics for downstream applications. In the depicted embodiment, the architecture may comprise Raw Data Layer (ARL) 121, Offline Feature Store (ARL Hive) 122, Online Feature Store (RLO ORACLE) 123, and ELK Stack (RLO) 124.

Raw Data Layer (ARL) 121 may represent the pipeline start with raw data from various sources, including: ETL Stage Cards 121a which may represent raw data from a cards ETL (extract, transform, load) process; ARL IDL Cards 121b which may represent raw data specifically for IDL (Interchange Data Layer) cards; LVE Stage Tables 121c which may represent raw data in staging tables from the LVE (Lending Value Engine) system. This raw data may then flow into the Decision Log Stage Tables 121d.

Offline Feature Store (ARL Hive) 122 may represent the raw data process that undergoes processing in the ARL Hive environment to generate feature data. It may comprise: Cards Account-level Features 122a which may be features derived at the account level from the cards raw data; and Cards Account-level Features Aggregated 122b which may be account-level features that are then aggregated, which may be at a higher level such as customer or household.

Online Feature Store (RLO ORACLE) 123 may represent the aggregated features from ARL Hive that are loaded into the RLO (Real-time Learning Optimizer) ORACLE database. The features may be organized into: Cards Account-level Features Aggregated 123a which may be the same aggregated features from ARL Hive; and FICO Decision Log State Table 123b which may be a state table tracking FICO credit score related data and decisions.

ELK Stack (RLO) 124 may represent the ELASTICSEARCH, LOGSTASH, KIBANA stack in the RLO environment. It may comprise: Elastic Index 124a which may represent the features data indexed in ELASTICSEARCH, enabling fast search and retrieval; and KIBANA Dashboards (Analytical & Operational Monitoring/Reporting) 124b which may represent KIBANA, the visualization layer of the ELK stack, that may be used to build dashboards for analytical reporting and operational monitoring on the features data.

KAFKA CLM Inbound Topic Processing (RLO) 125 may represent the indexed feature data that is processed and pushed to KAFKA topics for consumption by downstream applications. A KAFKA consumer may read from the feature topics and parses the data into Java objects for application use (step 125a), and another topic may ingest FICO credit decisioning responses and PDR along with action outcomes from SOM (Service Order Management). This process may enrich the feature data with decision outcomes. This pipeline may thus ingest raw data from multiple sources, process it in Hive to generate account-level and aggregated features, store the features in ORACLE, index them in ELASTICSEARCH for fast retrieval, visualize them in Kibana for reporting, and finally push the feature data to KAFKA topics for consumption by decisioning applications along with the actual decision outcomes.

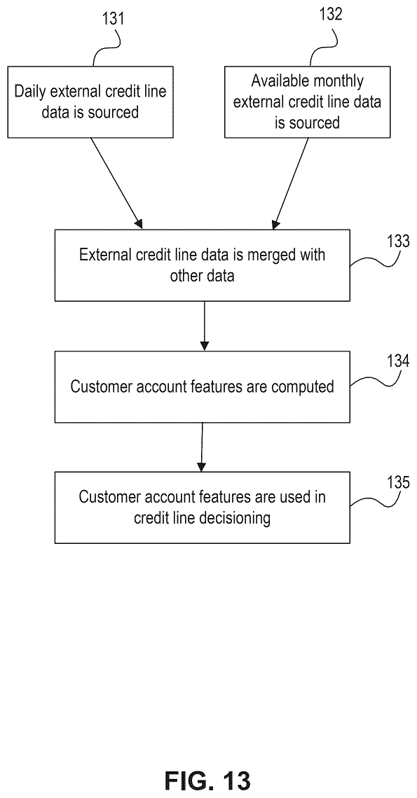

FIG. 13 is a flow chart of example operations that may be taken by credit line management systems described herein, consistent with disclosed embodiments. At step 131 daily external credit line data may be sourced. In some embodiments, for example, daily bureau data may be sourced from relational databases such as MySQL or PostgreSQL using SQL queries to retrieve relevant information. The sourced data may include transactional records, account balances, and other relevant financial metrics. Additionally, the data may be processed in real-time using streaming analytics tools.

At step 132 available monthly external credit line data may be sourced. In some embodiments, for example, available monthly bureau data may be sourced from external data providers such as credit reporting agencies or government databases. This data may include credit scores, payment histories, and other relevant information used to assess creditworthiness. The sourced data may be processed using data integration tools to ensure data quality and consistency.

According to some exemplary embodiments, different source applications may be dedicated to specific forms of data, such as transactional data, demographic data, or behavioral data. This may allow for efficient processing and storage of large datasets, reducing the risk of data inconsistencies and errors.

At step 133 external credit line data may be merged with other data. In some embodiments, for instance, bureau data may be merged with other data sources such as customer information from CRM systems or marketing analytics platforms. The merging process may involve data transformation, aggregation, and cleansing using tools to ensure data consistency and accuracy.

At step 134 customer account features may be computed. In some embodiments, for example, once the bureau data is merged with other data, customer account features may be computed using any suitable approach, such as a pyspark framework, machine learning algorithms, decision trees, or random forests. In some embodiments, the calculation process may include aggregations across records using SQL queries or data aggregation tools. After calculation, features may persist in online and offline stores for consumption by credit line management systems. This may allow for real-time access to customer account information and enables informed decision-making.

At step 135 customer account features may be used in credit line decisioning. Thus, the example operations facilitate real-time credit line decision-making, enabling financial institutions to make accurate and timely lending decisions.

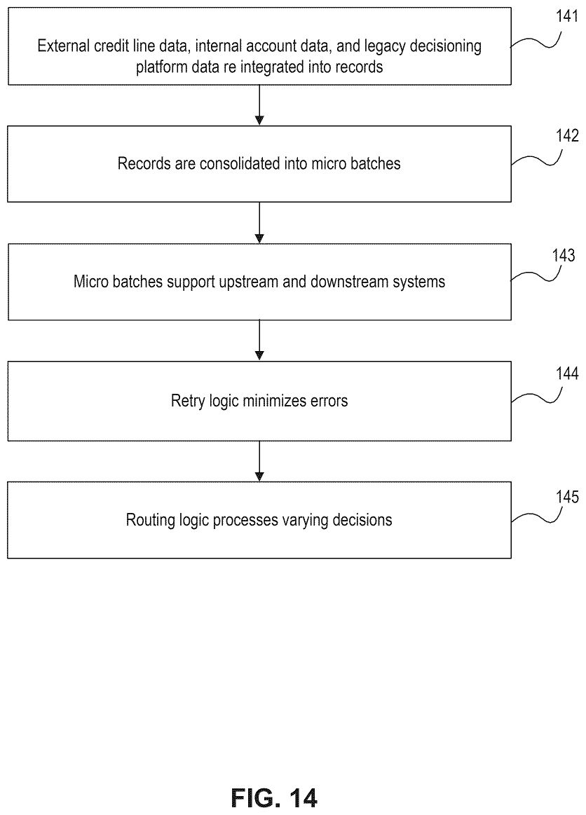

FIG. 14 is a flow chart of example operations that may be taken by credit line management systems described herein, consistent with disclosed embodiments. At step 141, Bureau data, internal account data, and legacy decisioning platform data may be integrated into records. This integration process may involve data cleansing, transformation, and mapping to ensure consistency and accuracy. The resulting records may then be stored in a centralized repository for further processing.

At step 142, records may be consolidated into micro batches. Micro batching may enable the efficient processing of large datasets by breaking them down into smaller, manageable chunks that can be processed independently. This approach may improve system performance and reduce latency.

Once records are consolidated into micro batches at step 142, at step 143, micro batches may support upstream and downstream systems. APIs may be used, for instance, such as REST or GRAPHQL. These APIs may enable the seamless exchange of data between different systems and services, facilitating real-time processing and decision-making. However, any other suitable process may be used.

At step 144, retry logic may minimize errors. In some embodiments, a credit line management system may experience connectivity errors that result in API calls returning errors. Thus, in some embodiments, retry logic may facilitate the resubmission of every called record that returned an error. In other embodiments, however, retry logic resubmits failed calls at set intervals, such as 30 minutes, to minimize connectivity failures and ensure data integrity.

Once retry logic minimizes errors at step 144, routing logic may process varying decisions at step 145. In some embodiments, routing logic may access credit line decisions, including credit line increases, decreases, and closures, and route respective records to audit logs or credit card processor systems for storage or subsequent use. In some embodiments, the routing logic may also involve machine learning models or decision trees to determine the optimal routing strategy based on specific business rules or criteria. For example, the routing logic may involve machine learning models that leverage data from the FDR, Written Communication Integration (WCI), and Bank Card Processing (CCH) components. For example, if a customer has a recent high-value transaction processed through the CCH and a large account balance in the FDR, the model might route them to a retention specialist who can offer personalized rewards via the WCI. Conversely, if a customer has a low credit score and recent missed payments, the system might generate an adverse action letter through the WCI and route them to a collections agent. The models can also use the FDR and CCH data to identify at-risk customers and proactively send them financial education materials or hardship program offers via the WCI. These examples are merely illustrative and are not intended to be exhaustive.

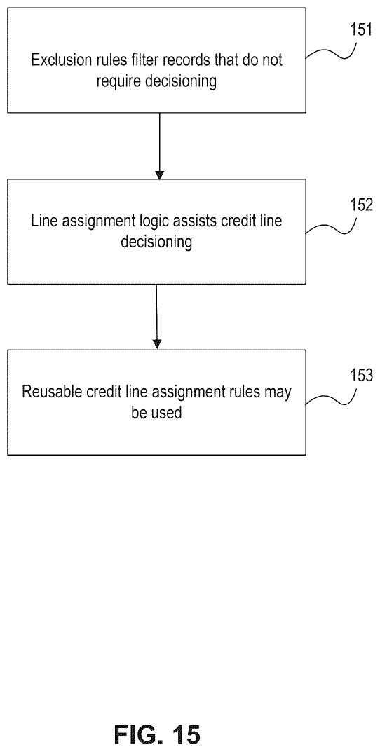

FIG. 15 is a flow chart of example operations that may be taken by credit line management systems described herein, consistent with disclosed embodiments. At step 151, exclusion rules may filter records that do not require decisioning. Exclusion rules may include global exclusion rules and local exclusion rules. For instance, a global exclusion rule might exclude all transactions above a certain amount, while a local exclusion rule might exclude specific types of transactions based on merchant category codes (MCCs). In some embodiments, the system may also utilize machine learning algorithms to dynamically update exclusion rules based on patterns in transaction data.

At step 152, line assignment logic may assist credit line decisioning. Line assignment logic may include retry logic and routing logic. For example, the system might employ a load balancer to distribute incoming requests across multiple servers, ensuring that no single server becomes overwhelmed. The retry logic may be implemented using a circuit breaker pattern, which detects when a service is experiencing errors and temporarily prevents further requests from being sent.

Once line assignment logic assists credit line decisioning at step 152, reusable credit line assignment rules may be reused at step 153. In some embodiments, credit line management architecture is highly reusable because all aspects and rules are designed to handle multiple types of product payloads. For example, the same architecture may be reused in consumer credit cards, business credit cards, home equity, and personal lending with minimal changes.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. Some steps may be deleted, added, or modified. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-9. (canceled)

10. A system comprising:
at least one processor; and
at least one memory storing instructions that, when executed by the at least one processor, cause the at least one processor to:
receive one or more records, based on customer account data;
provide the one or more records as inputs to a data orchestrator;
transmit the one or more records, using the data orchestrator, to a FICO platform;
access, using one or more application program interfaces, the one or more records;
extract one or more features from the one or more records;
provide the one or more features as inputs to a credit line decisioning system; and
assign, using the credit line decisioning system, a credit decision path based on the one or more features.

11. The system of claim 10, wherein the customer account data comprises at least one of a deposit account balance, an average balance, an account usage, a delinquency, a customer address, or a customer identification number.

12. The system of claim 10, wherein the data orchestrator comprises a consumer client, a FICO orchestrator, a data workflow, and a producer client.

13. The system of claim 10, wherein the credit line decisioning system comprises a decision orchestrator, a line management evaluator, and a line management assignor.

14. The system of claim 10, wherein the instructions further comprise:
generating, using the credit line decisioning system, a behavioral score based on the one or more features; and
assigning, using the credit line decisioning system, the credit decision path based on the behavioral score.

15. The system of claim 14, wherein the credit decision path is one chosen from the set of: credit line increase, credit line decrease, and credit line closure.

16. The system of claim 14, wherein the instructions further comprise:
transmitting the credit decision path to a downstream system.

17. The system of claim 10, wherein the instructions further comprise:
transmitting audit and reporting data to a reporting and analysis system.

18-20. (canceled)

21. The system of claim 10, wherein the data orchestrator is configured to combine data from multiple source applications into at least one micro batch for transmission to the credit line decisioning system.

22. The system of claim 21, wherein the at least one micro batch is transmitted at a set interval of time.

23. The system of claim 12, wherein the data workflow includes a predefined sequence of tasks to process and transform data from a raw format to a consumable format.

24. The system of claim 10, wherein the credit line decisioning system is further configured to apply exclusion rules to the one or more records.

25. A method comprising:
receiving one or more records, based on customer account data;
providing the one or more records as inputs to a data orchestrator;
transmitting the one or more records, using the data orchestrator, to a FICO platform;
accessing, using one or more application program interfaces, the one or more records;
extracting one or more features from the one or more records;
providing the one or more features as inputs to a credit line decisioning system; and
assigning, using the credit line decisioning system, a credit decision path based on the one or more features.

26. The method of claim 25, wherein the method further includes:
generating, using the credit line decisioning system, a behavioral score based on the one or more features; and
assigning, using the credit line decisioning system, the credit decision path based on the behavioral score.

27. The method of claim 25, wherein the data orchestrator is configured to combine data from multiple source applications into at least one micro batch for transmission to the credit line decisioning system.

28. The method of claim 27, wherein the at least one micro batch is transmitted at a set interval of time.

29. The method of claim 25, wherein the data orchestrator includes a data workflow, the data workflow including a predefined sequence of tasks to process and transform data from a raw format to a consumable format.

30. The method of claim 25, wherein the credit line decisioning system is further configured to apply exclusion rules to the one or more records.
